(19) United States
(12) Patent Application Publication
(10) Pub. No.: US 2012/0097043 A1
(43) Pub. Date: Apr. 26, 2012

(54) THERMO-FUSE FOR A PUMP OF A BEVERAGE MACHINE

(76) Inventor: Renzo Moser, Gummenen (CH)

(21) Appl. No.: 13/378,288

(22) PCT Filed: Jun. 21, 2010
(86) PCT No.: PCT/EP2010/058689

§ 371 Date: Dec. 14, 2011

(30) Foreign Application Priority Data
Jun. 24, 2009 (EP) 09008254.6

(51) Int. Cl. H05B 1/02; A23L 2/00

(52) U.S. Cl. 99/323.3; 219/494

(57) ABSTRACT

A pump for a beverage preparation machine which includes a heat-radiating electric arrangement; and a thermo-fuse connected to the electric arrangement via an electric connection. The thermo-fuse is connectable to a power source for powering the heat-radiating electric arrangement via the thermo-fuse. The thermo-fuse is in thermal communication with the heat-radiating electric arrangement so as to disconnect the electric arrangement from the power source when the thermo-fuse reaches a predetermined maximum temperature in reaction to an excessive heat radiation from the electric arrangement. The thermo-fuse and the heat-radiating electric arrangement are so configured that heat radiating from the electric arrangement to the thermo-fuse is predominantly conducted along the electric connection from the electric arrangement to the thermo-fuse.

### FIELD OF THE INVENTION

The present invention relates to the protection of electrically powered pumps, typically of a beverage preparation machine, against electric overheating.

For the purpose of the present description, a “beverage” is meant to include any liquid food, such as tea, coffee, hot or cold chocolate, milk, soup, baby food, etc. . . .

### BACKGROUND ART

Certain beverage preparation machines use capsules containing ingredients to be extracted or to be dissolved; for other machines, the ingredients are stored and dosed automatically in the machine or else are added at the time of preparation of the drink.

Various beverage machines, such as coffee machines, are arranged to circulate liquid, usually water, from a water source that is cold or heated by heating means, to a mixing or infusion chamber where the beverage is actually prepared by exposing the circulating liquid to a bulk or pre-packaged ingredient, for instance within a capsule. From this chamber, the prepared beverage is usually guided to a beverage dispensing area, for instance to a beverage outlet located above a cup or mug support area comprised or associated with the beverage machine. During or after the preparation process, used ingredients and/or their packaging is evacuated to a collection receptacle.

Most coffee machines possess filling means that include a pump for liquid, usually water, which pumps the liquid from a source of water that is cold or indeed heated through heating means, such as a heating resistor, a thermoblock or the like. For instance, U.S. Pat. No. 5,943,472 discloses a water circulation system for such a machine between a water reservoir and a hot water or vapour distribution chamber, for an espresso machine. The circulation system includes valves, a metallic heating tube and a pump that are interconnected with each other and with the reservoir via a plurality of silicone hoses that are joined together by clamping collars.

The known beverage preparation devices can be equipped with various types of pumps for promoting liquid within the device.

For instance, U.S. Pat. No. 2,715,868 discloses a beverage preparation machine for extracting a beverage ingredient within an extraction chamber supplied in a cartridge by water guided into the extraction chamber and forced through the cartridge. The pump is of the rotary type and has blades operating in a pump chamber to transfer liquid under pressure to the extraction chamber. U.S. Pat. No. 5,392,694 discloses an espresso machine with a piston pump mounted in the machine's housing. The pump has a reciprocating piston that is actuated by an eccentric drive having a connecting rod that is engaged with the piston. U.S. Pat. No. 5,992,298 discloses a beverage preparation machine with a vibrating pump suspended in mobile or overhung manner, the vibrations being transferred to an in-line heater to vibrate the heater with the view of reducing liming in the heater. U.S. Pat. No. 6,554,588 discloses a composite piston for vibration pumps suitable for use in espresso machines.

Generally speaking, electric pumps used in beverage preparation machines are provided with a water drive device, such as a reciprocating piston or rotary blades or turbine. This water drive device is in turn driven by an electric motor, such as one or more electrically powered solenoids cooperating with one or more magnets relatively movable thereto.

To prevent overheating and safety-related issues resulting from the electric powering of the motor, such pumps incorporate a thermo-fuse that is in serial electric mounting with the powering of the pump.

In conventional pumps, the thermo-fuse is mounted in or on the pumps's housing and in thermal communication through the walls of the housing with the motor so as to react to the heat radiated. The walls of the housing in or on which the thermo-fuse is mounted are made of thermoplastic or other insulating material having typically a thermal conductivity of the order of 0.01 to 1 W·m⁻¹·K⁻¹. This affects the heat radiation through the walls to the thermo-fuse and the reliability of the thermal safety system. An embodiment of this type of prior art pumps is described in greater details in relation with the appended FIG. 1.

### SUMMARY OF THE INVENTION

The invention thus relates to a pump for a beverage preparation machine.

This pump comprises: a heat-radiating electric arrangement; and a thermo-fuse connected to the electric arrangement via an electric connection. The thermo-fuse is connectable to a power source for powering the heat-radiating electric arrangement via the thermo-fuse. The thermo-fuse is in thermal communication with the heat-radiating electric arrangement so as to disconnect the electric arrangement from such a power source when the thermo-fuse reaches a predetermined maximum temperature in reaction to an excessive heat radiation from the electric arrangement.

In accordance with the invention, the thermo-fuse and the heat-radiating electric arrangement are so configured that heat radiating from the electric arrangement to the thermo-fuse is predominantly conducted along the electric connection from the electric arrangement to the thermo-fuse.

During normal operation of the pump, when electrically powered, the heat-radiating electric arrangement would typically generate heat. Such a heat generation would be acceptable within certain limits. In case of overheating, typically when the pump runs dry, the heat-generating electric arrangement generates heat that may exceed a predetermined maximum. In order to avoid any safety issue due to excessive heat generation, the thermo-fuse interrupts the powering of the heat-generating electric arrangement when a maximum temperature is detected.

By providing a thermal transfer from the heat-generating electric arrangement to the thermo-fuse predominantly by the highly conductive electric connection, instead of through an insulating housing of the pump, the thermal transfer from the heat-generating electric arrangement to the thermo-fuse is more direct and reliable.

As a consequence, the time needed for the thermo-fuse to react to a temperature variation of the heat-generating electric arrangement is shorter. Consequently, the critical temperature at the level of the thermo-fuse to cut-off the powering circuit can be set higher than with the prior art configurations in which the thermal flow has first to pass a thermally poorly conductive housing (leading to a significant temperature gradient). Hence, the critical temperature, or cut-off temperature, of the thermo-fuse may be set at a level that is closer to the admissible maximum temperature of the heat-generating electric arrangement.

Since the cut-off temperature of the thermo-fuse can be set at a higher level, the thermo-fuse is less likely to be triggered due to the general heat up of the environment in which the pump is inserted, e.g. in a beverage machine comprising further heat-generating devices likely to influence the thermo-fuse of the pump of the invention, such as a heat-generating electric transformer of the beverage preparation machine.

The thermo-fuse and the heat-radiating electric arrangement may be so configured that at least 75%, 85% or 95% of heat passing from the electric arrangement to the thermo-fuse is conducted by the electric connection from the electric arrangement to the thermo-fuse.

The electric connection from the heat-radiating electric arrangement to the thermo-fuse may have a heat conductivity of at least 20 W·m⁻¹·K⁻¹, in particular of more than 80 W·m⁻¹·K⁻¹ such of as of at least 150 W·m⁻¹·K⁻¹.

Moreover, the electric connection from the heat-radiating electric arrangement to the thermo-fuse is typically a rigid connection, e.g. via rigid terminals of the heat-radiating electric arrangement and/or of the thermo-fuse, or via a plug and socket configuration between the electric arrangement and the thermo-fuse.

Typically, the electric connection from the heat-radiating electric arrangement to the thermo-fuse is made of at least one of thermally highly conductive aluminium, copper and alloys thereof. Instead of using highly thermally conductive materials such as aluminium and/or copper, it is also possible to use less conductive materials, such as for instance steel. In this latter case, the lower conductivity of the material may be compensated by a larger cross-section of the electric connection.

The thermo-fuse may be any kind of thermal interrupting device. The thermo-fuse may be a one-way fuse or “thermal link”. In this case, the thermo-fuse is a single use component that must be replaced once triggered. Alternatively, the thermo-fuse is a reversible fuse. In this case, the reversible thermo-fuse may be a thermal switch or a thermostat.

In one embodiment, the pump of the invention is a pump for driving liquid. This pump typically comprises a heat-radiating electric motor, in particular including a solenoid e.g. to drive a reciprocating piston, as a heat-generating electric arrangement.

In another embodiment, the pump of the invention is a heater for heating liquid, in particular an in-line heater for heating circulating liquid. The heater normally comprises an electric heating resistor as a heat-radiating electric arrangement.

A further aspect of the invention relates to a beverage preparation machine that comprises a pump as described above.

For instance, the machine is a coffee, tea or soup machine, in particular a machine for preparing within an extraction unit a beverage by passing hot or cold water or another liquid through a capsule or pod containing an ingredient of the beverage to be prepared, such as ground coffee or tea or chocolate or cacao or milk powder. The machine may comprise a brewing unit for housing this ingredient. Typically, the machine includes one or more of a pump, heater, drip tray, ingredient collector, liquid tank and fluid connection system for providing a fluid connection between the liquid tank and the brewing unit, etc. . . . The general configuration of a fluid circuit between the liquid reservoir and a heater for such a machine is for example disclosed in greater details in co-pending applications PCT/EP08/067072 and PCT/EP09/053368.

### BRIEF DESCRIPTION OF THE DRAWINGS

The invention will now be described with reference to the schematic drawings, wherein:

FIG. 1 schematically shows a comparative embodiment of a state of the art pump with a thermo-fuse; and

FIGS. 2 to 3a illustrate different views and parts of a pump with a thermo-fuse in accordance with the invention, FIG. 3a showing an enlarged view of Detail X of FIG. 3.

### DETAILED DESCRIPTION

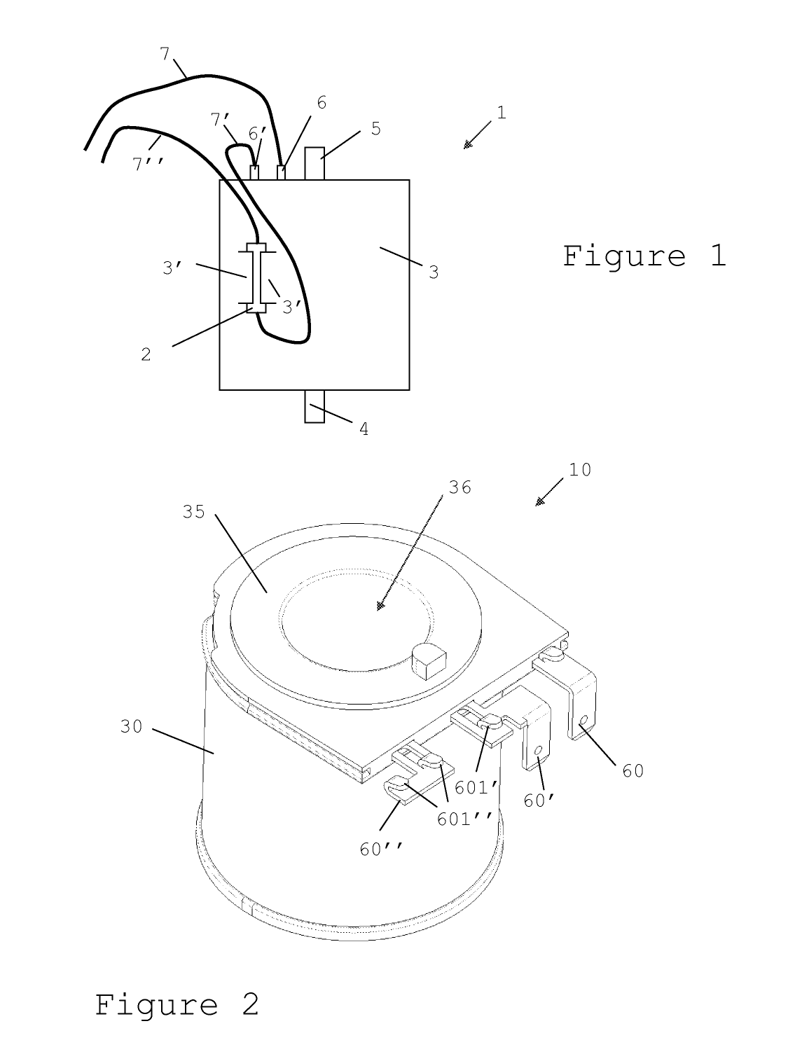

FIG. 1 schematically illustrates a state of the art pump 1 of a beverage preparation machine with a thermo-fuse 2.

Pump 1 has a housing 3 an inlet 4 and outlet 5 for the circulation of water therethrough. Inside housing 3, pump 1 has a pump chamber with a reciprocating piston driven by an alternative magnetic field generated by electric current circulating in a solenoid surrounding the pump chamber (not shown). Such pumps are well known in the art. The solenoid is electrically connected by two electric terminals 6,6′ that are joined via flexible cables 7,7′,7″ to an electric power source (not shown) via thermo-fuse 2.

Thermo-fuse 2 is secured between a pair of flanges 3′ against housing 3. Housing 3 and flanges 3′ being integral and made of thermoplastic material. Thermo-fuse 2 is connected to terminal 6′ and to the power source via flexible cables 7′,7″.

When the solenoid inside housing 3 generates so much heat as to cause a safety issue, heat radiates generally perpendicularly through a wall of thermoplastic housing 3. A fraction of the generated heat heats up thermo-fuse to a temperature reaching a predetermined maximum temperature triggering thermo-fuse 2. The triggering of thermo-fuse 2 interrupts the electric connection 7′,7″ between the power source and terminal 6′ of pump 1 and thus the powering of the pump's solenoid is interrupted.

Since housing 3 is made of an insulating material covering the solenoid of pump 1, a temperature gradient will form through housing 3 depending on the speed of temperature variation at the level of the solenoid of pump 1. Moreover, the temperature at the level of the thermo-fuse will also depend on the thermal conductivity of the elements forming pump 1 and of the surrounding elements of the system in which pump 1 is inserted for use. Consequently, the cut-off temperature at the level of thermo-fuse 2 will have to be set below the maximum acceptable temperature of the solenoid and based on a estimate average conductivity of heat to the thermo-fuse 2 and temperature reaction at the level of thermo-fuse 2.

It follows that for safety reasons, the cut-off temperature of thermo-fuse 2 has to be set with a margin below the actual temperature that would cause a safety problem, in order to take into account the above variations of the temperature response at the level of the thermo-fuse to a temperature variation at the level of the heat-radiating electric arrangement, such as a solenoid. Moreover, since the cut-off temperature of the thermo-fuse is set at a reduced level, the thermo-fuse becomes more sensitive to other heat generating elements of a system in which the pump is inserted, e.g. to a heater such as an in-line heater or to a controller, that contribute—depending on a particular overall operation of such a system—to drive the thermo-fuse to the reduced cut-off temperature without involving an actual safety problem.

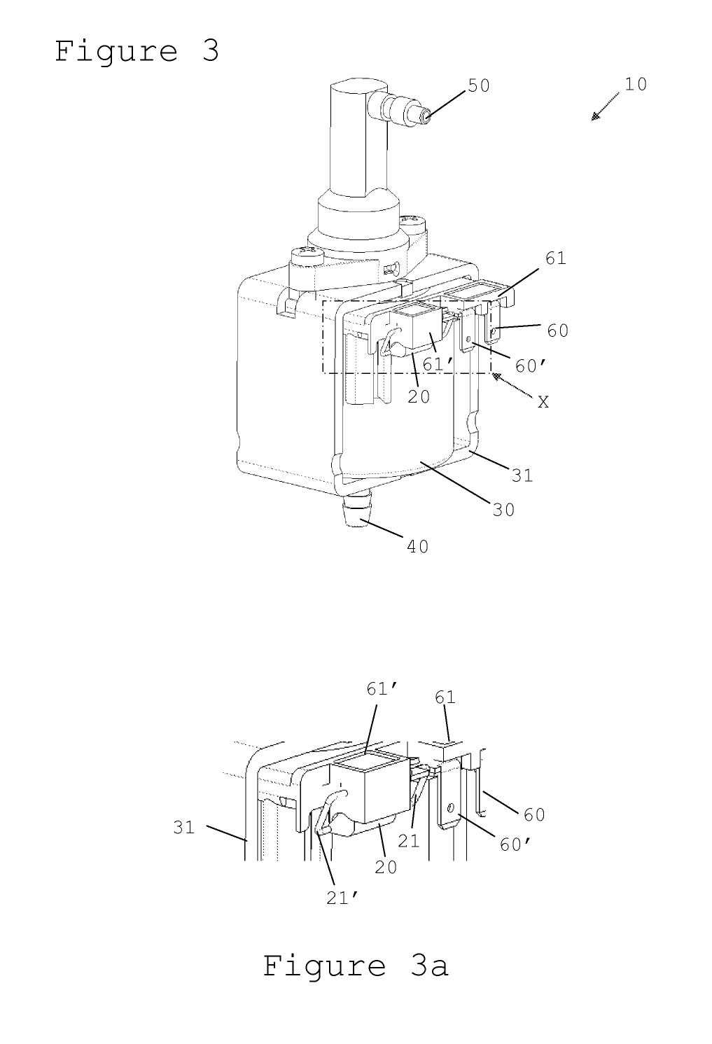

In contrast, FIGS. 2 to 3a illustrate a pump 10 in accordance with the invention that provides a solution to the previously mentioned problems. FIG. 3 shows a perspective view of pump 10. FIG. 3a is an enlarged view of a detail X of pump 10 shown in FIG. 3 and FIG. 2 illustrates part of pump 10, in particular a solenoid block 35, as a heat-radiating electric arrangement, with its electrical rigid connectors 60,60′,60″ for connection to a thermo-fuse 20 and to an external power source (not shown).

Pump 10 has a water inlet 40 and a water outlet 50 extending from a protective housing 30, typically made of insulating plastic material, that is secured in a frame for securing the assembly of pump 10 together and optionally securing pump 10 within a system such as a beverage preparation machine.

Connectors 60 and 60′ are arranged for connecting pump 10 to a power source. Thermo-fuse 20 has a pair of rigid terminals 21,21′ that are connected, on the one hand to connector 60′ and on the other hand to connector 60″. Moreover connector 60′ has a fastener 601′ and connector 60″ has a pair of fasteners 601″ for fastening terminals 21,21′ of thermo-fuse 20. Hence, thermo-fuse 20 can be removably mounted onto connectors 60′,60″ via fasteners 601′,601″ and thus can be easily replaced if needed, in particular if thermo-fuse 20 is a one-way fuse.

The connection between thermo-fuse 20 and connectors 60′,60″ is mechanically protected and electrically insulated by cover 61′ mounted on frame 31. It is of course also possible to provide only one such fastener on each side of the thermo-fuse or to connect the thermo-fuse by other means to the connectors, e.g. by welding.

The solenoid within solenoid block 35 has a first extremity connected to connector 60, e.g. the neutral polarity of a corresponding power source, and a second extremity connected to connector 60″ which is in turn connected to connector 60′ via intermediate thermo-fuse 20. Connector 60′ is then connected to the phase polarity of a the power source (not shown). The power source may be controlled via a control unit of the system, e.g. a beverage preparation machine, in which pump 10 is mounted.

Thermo-fuse 20 is in thermal communication with the heat-radiating electric arrangement, that is to say with the solenoid in block 35 so as to disconnect it from the power source when the thermo-fuse reaches a predetermined maximum temperature in reaction to an excessive heat radiation from the electric arrangement (solenoid). Hence the electric circuit of pump 10 to the polarities of a power source is closed as long as thermo-fuse 20 does not cause an interruption thereof.

In accordance with the invention, thermo-fuse 20 and the heat-radiating electric arrangement (solenoid) are so configured that heat radiating from the electric arrangement to thermo-fuse 20 is predominantly conducted along the electric connection 21′,60″ from the electric arrangement (solenoid) to thermo-fuse 20.

In other words, instead of mainly communicating thermal variations from the solenoid to the thermo-fuse via the walls of the insulating housing 30 of pump 10, as in prior art configurations, the heat generated in the solenoid by the passage of current therethrough, is predominantly communicated via the highly conductive electric connectors 21′,60″. Hence, more than 50%, typically more that 70, 80 or even 90%, of the heat communicated from the solenoid in block 35 to the thermo-fuse 20 outside block 35 is canalised and passed via the (thermally) well conductive electric connectors 60″ and 21′. This communication is subjected to a much smaller temperature gradient, and leads to a significantly faster temperature response at the level of thermo-fuse 20 in response to a temperature variation at the level of the solenoid. Hence, the safety margin for the cut-off temperature of thermo-fuse 20 is significantly lower than for prior art configurations, i.e. the cut-off temperature can be set at a higher level closer to the acceptable maximum temperature of the solenoid, and the thermo-fuse 20 is less likely to be affected by side-heating in the system and less likely to cause excessively early cut-off.

Typically, connections 21′ and 60″ can be made of copper and/or aluminium and have an overall thermal conductivity in the range of about 0.01 to 0.05W·K⁻¹.

As mentioned above, electric connections 21′,60″ from heat-radiating electric arrangement 35 (solenoid) to thermo-fuse 20 are rigid and non flexible so as to permit automatic handling and assembly thereof. This reduces the assembly costs and the risk of assembly errors. Thermal conduction may also be achieved by a flexible connection.

FIGS. 2 to 3a further illustrate a protection member 61 integral with frame 31 extending above connectors 60 and 60′. In the middle of solenoid block 35 extends a cavity 36 for housing a pump chamber containing a piston (not shown), reciprocating under the effect of the magnetic field generated by the solenoid in block 35, for driving water from pump inlet 40 to pump outlet 50. Reciprocating piston may be driven back and forth under the effect of the induced magnetic field, or it may be connected to a return spring so that it is driven by the effect of the magnetic field in one direction and by the effect of the stressed return spring in the other direction. Such magnetic and mechanical pump arrangements as well as other suitable arrangements are well known in the art and may be adapted to the thermo-fuse arrangement according to the invention.

FIGS. 2 to 3a illustrate a pump 10 for a beverage preparation machine.

1.-15. (canceled)

16. A pump for driving a liquid in a beverage preparation machine comprising:
a heat-radiating electric arrangement; and
a thermo-fuse connected to the electric arrangement via an electric connection, with the thermo-fuse connectable to a power source for powering the heat-radiating electric arrangement via the thermo-fuse, and being in thermal communication with the heat-radiating electric arrangement so as to disconnect the electric arrangement from the power source when the thermo-fuse reaches a predetermined maximum temperature in reaction to an excessive heat radiation from the electric arrangement,
wherein the thermo-fuse and the heat-radiating electric arrangement are configured such that heat radiating from the electric arrangement to the thermo-fuse is predominantly conducted along the electric connection from the electric arrangement to the thermo-fuse.

17. The pump of claim 16, wherein the thermo-fuse and the heat-radiating electric arrangement are as configured such that at least 75% of heat radiating from the electric arrangement to the thermo-fuse is conducted by the electric connection from the electric arrangement to the thermo-fuse.

18. The pump of claim 17, wherein the thermo-fuse and the heat-radiating electric arrangement are as configured such that at least 85% or at least 95% of heat radiating from the electric arrangement to the thermo-fuse is conducted by the electric connection from the electric arrangement to the thermo-fuse.

19. The pump of claim 16, wherein the electric connection from the heat-radiating electric arrangement to the thermo-fuse has a heat conductivity of at least 20 W·m^{31 1}·K⁻¹.

20. The pump of claim 19, wherein the electric connection from the heat-radiating electric arrangement to the thermo-fuse has a heat conductivity of greater than 80 W·m⁻¹·K⁻¹.

21. The pump of claim 19, wherein the electric connection from the heat-radiating electric arrangement to the thermo-fuse has a heat conductivity of at least 150 W·m⁻¹·K⁻¹.

22. The pump of claim 16, further comprising first and second connectors for connection to a power source and a third connector, the heat-radiating electric arrangement being connected to the first and third connectors and the second and third connectors being connected via the thermo-fuse.

23. The pump of claim 22, wherein the second connector has a fastener and the third connector has a further fastener for fastening terminals of the thermo-fuse.

24. The pump of claim 22, wherein the thermo-fuse is welded to the second and third connectors to provide a secure connection.

25. The pump of claim 22, wherein the electric connection from the heat-radiating electric arrangement to the thermo-fuse is a rigid connection.

26. The pump of claim 16, wherein the electric connection from the heat-radiating electric arrangement to the thermo-fuse is made of at least one of aluminum, copper, or alloys thereof.

27. The pump of claim 16, wherein the thermo-fuse is a one-way fuse.

28. The pump of claim 16, wherein the thermo-fuse is a reversible fuse.

29. The pump of claim 16, wherein the heat-radiating electric arrangement includes a solenoid.

30. A beverage preparation machine comprising a pump as defined in claim 16.
